(19) United States
(12) Patent Application Publication
(10) Pub. No.: US 2004/0250424 A1
(43) Pub. Date: Dec. 16, 2004

(54) Snake blade with light

(76) Inventor: Robert E. Glover, Winnabow, NC (US)

Correspondence Address: Robert E. Glover, 1342 Cherry Tree RD, Winnabow, NC, 28479, US

(21) Appl. No.: 10/459,166

(22) Filed: Jun. 12, 2003

(51) Int. Cl. B26B 11/00

(52) U.S. Cl. 30/123

(57) ABSTRACT

With a long handle and a wide blade and a flash light attached to handle shinning down center of blade the snake blade with light makes it much safer to kill a poison snake especially at night the snake blade with light was not designed to kill harmless snakes

### BACKGROUND OF THE INVENTION

As I was watching T.V. one night I heard my dog barking loud. I walked outside stepping off my porch to see what was happening. I heard a hessing sound and looked down by my feet it was a large copper head snake, moving very quickly I ran to get a shovel to kill it. After returning I relized how close I had came to beging bit buy a poision snake. I also relized how close I was going to have to get with the shovel to kill it so I went and got my hoe. Still I had to get to close and it was hard to see even with porch light on. I then went into the house got my shotgun killed it.

As time went on I thought of single mothers with small children that don't have guns anybody who don't have a gun, there only means are usualy a hoe or shovel, that's why I invented the snake blade with light. It has long handle wide blade and flash light is mounted and clamped and shines down center of blade.

### BRIEF SUMMARY OF THE INVENTION

The advantage's of the snake blade with light are first the blade its (12 inches) long (2 inches) wide from bottom of blade to top of oak handle is (5 feet 11 inches) thats the second reason height. The third reason the handle carries a D cell flash light that shines down center of blade forth reason the snake blade with light on can easyaly be carried in one hand giving you a free hand to check mail box car windows take trash out at night where ever the blade goes the light shines down center of blade.

One can see the advantage's of the snake blade with light over a shovel or a hoe or a stick or a piece of long pipe for safely killing a posion snake day or especialy at night the flash light clamp is a acessary for night time use if desired the clamp can be taken off the clamp is designed for stardard D cell flash light weight of the snake blade with light including clamp with out flash light in it is (3 pounds 15 ounces)

### BRIEF DESCRIPTION OF THE SEVERAL VIEWS OF THE DRAWING

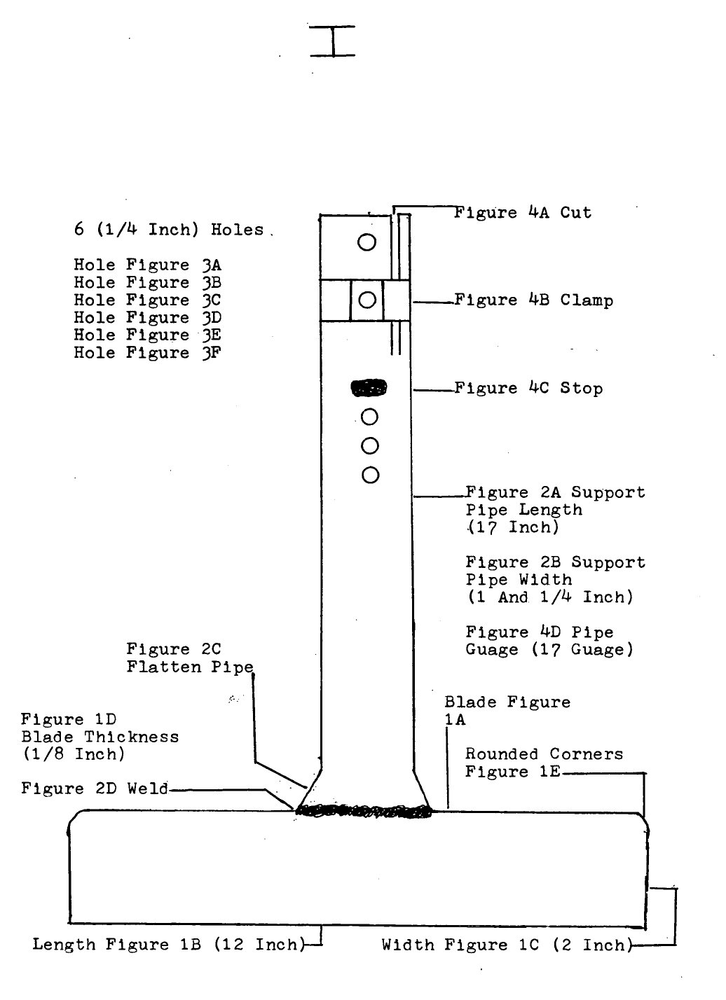

Page 1 (FIG. 1A 1B 1C 1D shows size of blade (FIG. 1E shows top corners rounded off

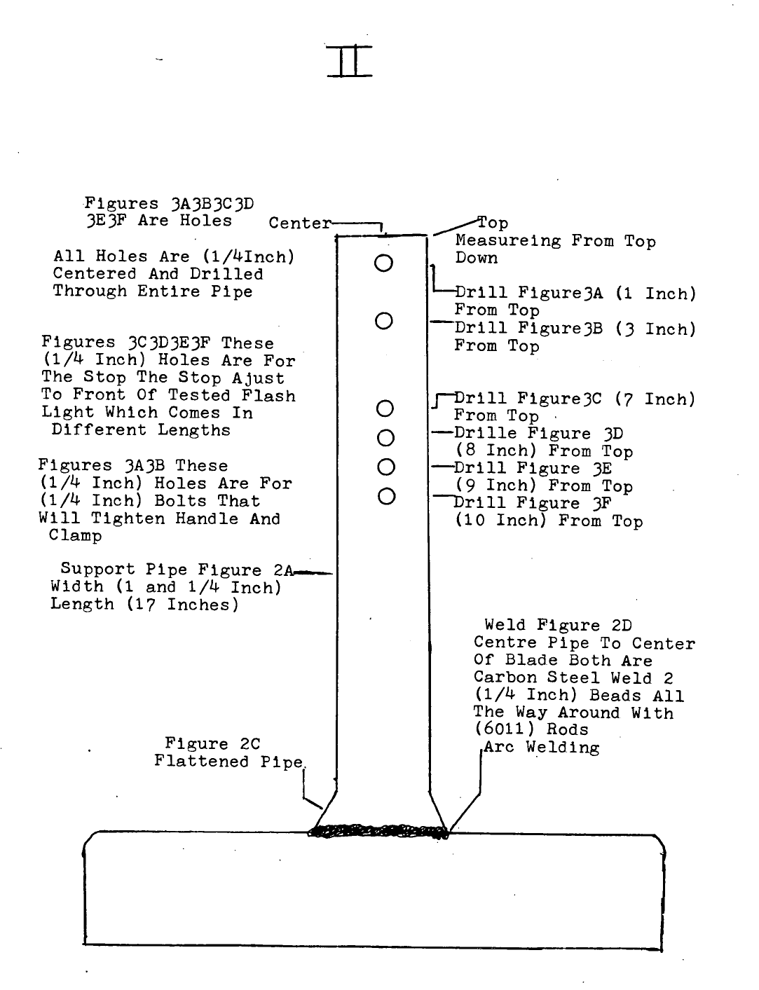

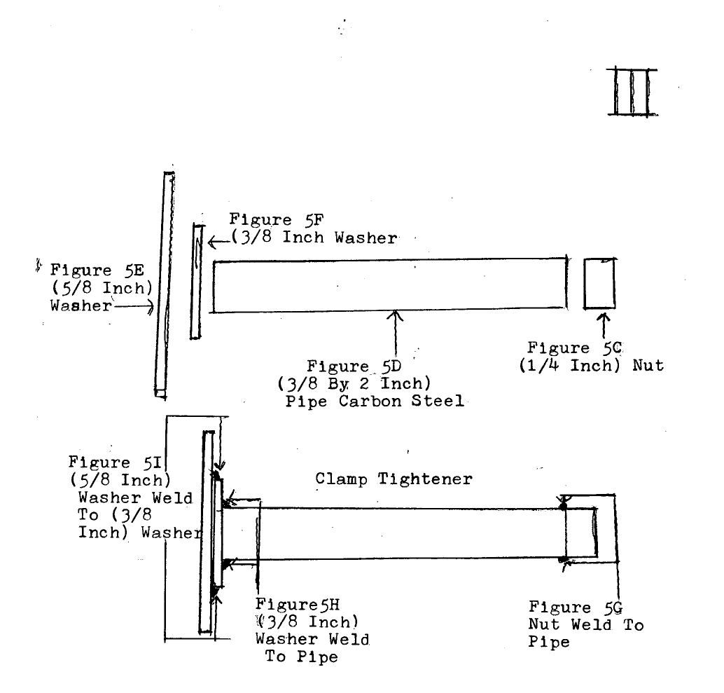

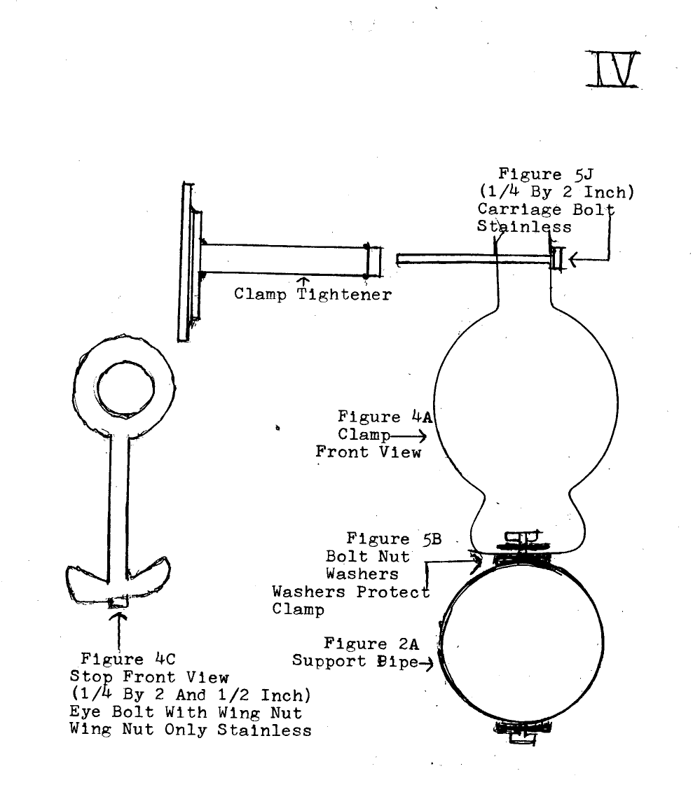

(FIG. 2A 2B) show size of support pipe the support pipe supports blade, clamp, oak handle, stop, bolts washers nuts. (FIG. 2C) shows bottom of support pipe that has been flatten so it can be welded to blade. (FIG. 2D) shows weld first view.

(FIG. 3A 3B 3C 3D 3E 3F) are all (¼ inch) holes that will be drilled in support pipe first view.

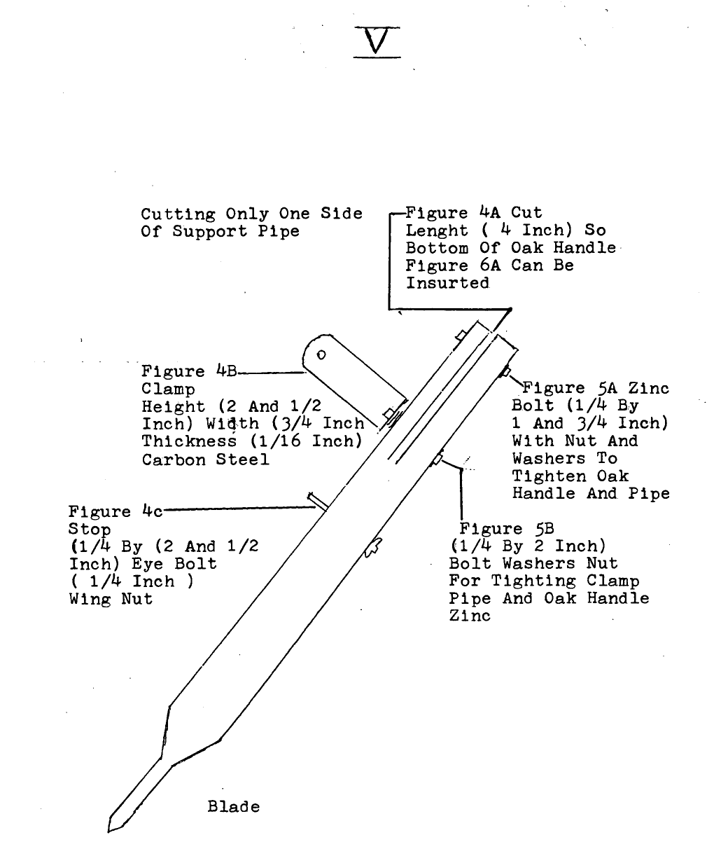

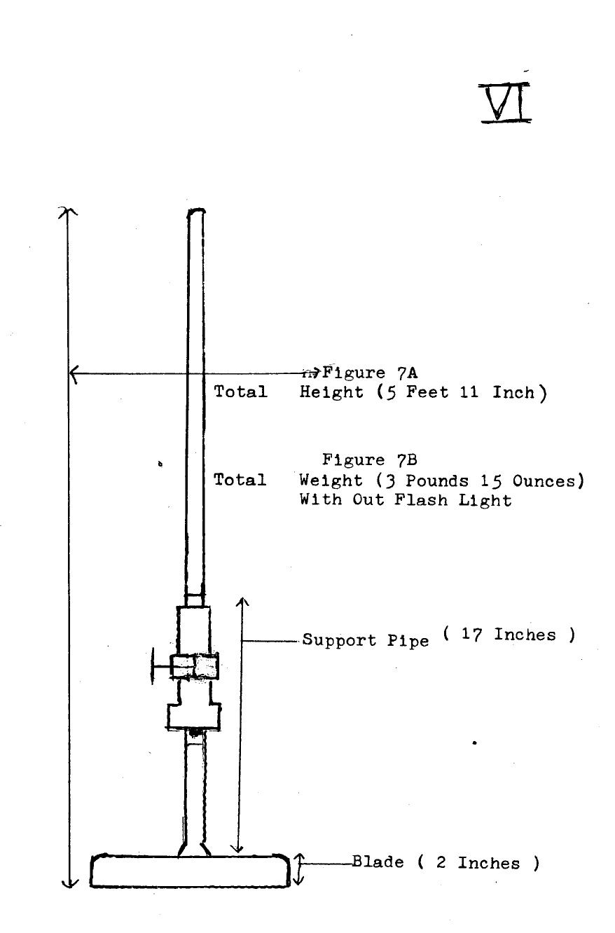

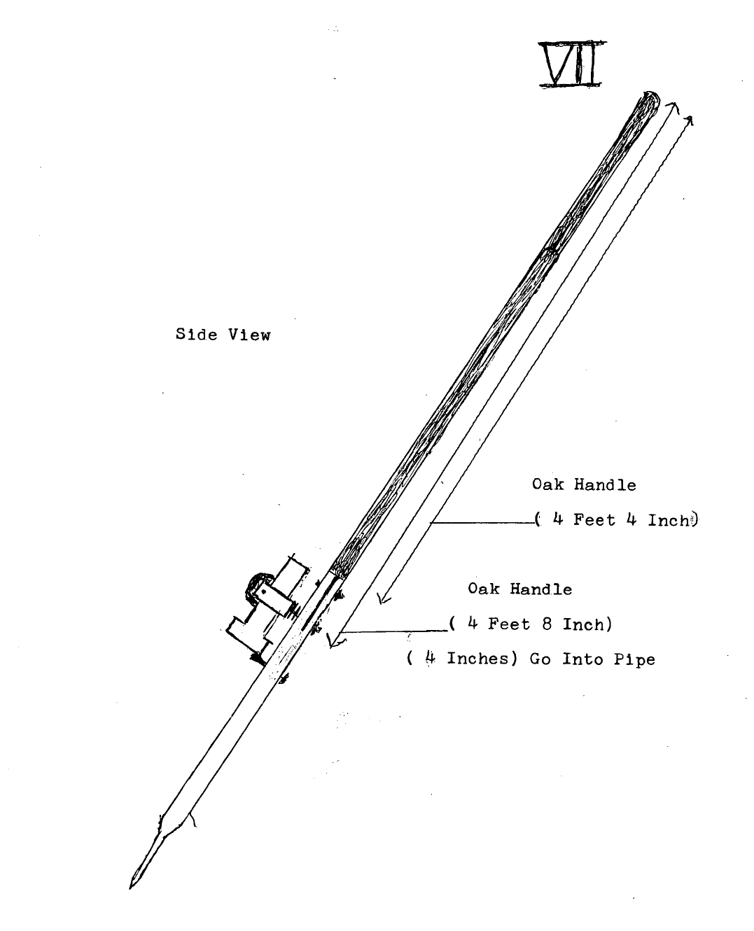

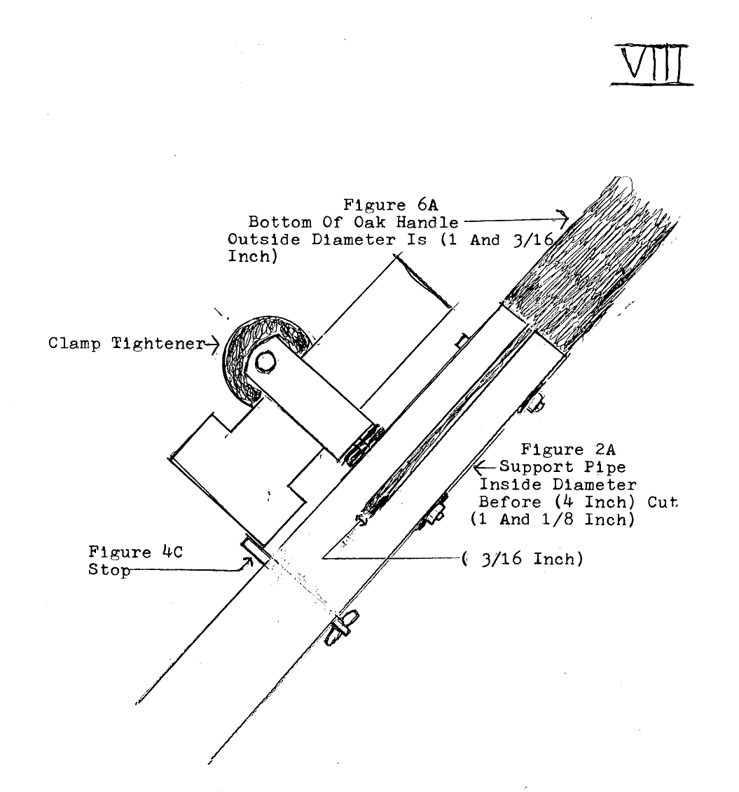

(FIG. 4A) shows a (4 inch) cut this cut will be made from top stright down one side only so bottom of oak handle can be incerted (4 inches) first view. (FIG. 4B) shows clamp that will hold and clamp flash light first view. (FIG. 4C) stop the stop is a (¼ by 2 and ½ inch) eye bolt with wing nut. Its for bottom front of flash light first view. The eye bolt adjust up and down (¼ inch) holes. (FIG. 4D) is guage of support pipe guage is (17) originily support pipe was made for top hand rail chain lenth fence.

Page 2 (FIG. 3A 3B 3C 3D 3E 3F) shows location and tells what each (¼ inch) hole is for. (FIG. 2A 2B 2C 2D) shows support pipe size pipe flatten and a more detailed description of weld. Page 5 (FIG. 4A) shows side view of (4 inch) cut so bottom of oak can be incerted. (FIG. 5A 5B) give bolt washers and nut sizes and their use. (FIG. 4B 4C) are sides views of clamp and stop. (FIG. 5C 5D 5E 5F) page 3 view of unwelded clamp tightener (FIG. 5g 5H 5I) each will be a top and bottom spot weld. The drawing of clamp tightener is on page 3. Page 4 (FIG. 4a) show front view of clamp orignaly clamp was (1 and ¼ inch) EMT conduit pipe hanger number (2 and ½) (FIG. 5J) shows (2 inch) carriage bolt reason for longer bolt so clamp tightener can tighten and losen ajustment for flash light handle no wrinches needed. All theads are alway complely covered with the clamp tightener. (FIG. 2a) pipe support (FIG. 5B) shows bolt washers nut (FIG. 4c) shows stop.

Drawing on pages 6 and 7 show (FIG. 7A) total height (FIG. 7B) shows total weight with out flash light total height (5 feet 11 inches) total weight (3 pounds 15 ounces) all bolt washers nuts are carbon steel zinc coated except (FIG. 5J) page 4 it will be a (2 inch) stainless carriage bolt and the wing nut only that goes with eye bolt stop FIG. 4C) but not eye bolt. The blade will be sharpened on both sides all metal will be cleaned filed if needed and painted drawing page 8 shows out side diameter of bottom of oak handle which is (1 and 3/16 inch) and a side view of flash light clamp and stop.

### DETAILED DESCRIPTION OF THE INVENTION

The most inportant piece of material in the snake blade with light is the pipe. The pipe will support blade, the oak handle the clamp the stop and the bolt nut and washers. The pipe must also be strong enough for welding, but light in weight the inside diameter of pipe needs to be (1 and ⅛ inch) so oak handle can be incerted. In my years working as a pipe fitter and pipe welder I knew finding that was going to be hard. Having designed a plan of curring a slidding measuring guage that measurers ID and OD. I finaly found (1 and ⅜ inch) top hand rail pipe for chain lence fence. Its called (1 and ⅜ inch) but its outside diameter is (1 and ¼ inch) its inside diameter is (1 and ⅛ inch). Its guage is 17 making it to be the pipe I need. To start as seen on drawing page 1 and 2 cut pipe which now is called support pipe (FIG. 2A) (17 inches long). (FIG. 2B) pipe width (1 and ¼ inch) (FIG. 2c) shows bottom of pipe that has been flatten.

The support pipe is flatten doubling the guage or thickness for welding as its shown in (FIG. 2D), the support pipe is carbon steel. (FIG. 1A 1B 1C 1D 1E) shows blade size and top corners that have rounded off. The blade is carbon steel its (12 inches) long (2 inches) wide (⅛ inch) thick its center is centered with flattened bottom of support pipe and welded as seen on (FIG. 2d) drawing page 1 and 2 the blade is arc welded with 6011 rods (¼ inch) bead down both sides twice or all the way around it. (FIG. 3a 3B 3C 3D 3E 3F) are (¼ inch) holes that are drilled in center of support pipe measuring from top down (1 inch) drill hole for tighten oak handle and pipe (3 inches) from top for clamp and oak handle to be tightened. The next 4 holes from the top will be drilled (7 inch) (8 inch) (9 inch) (10 inch) These holes for a (¼ by 2 and ½ inch) eye bolt that works as a stop

Before explaining (FIG. 4c) the stop. The clamp that holds and clamps flash light must be explained first the clamp tightener must be made. Taking a (⅜ inch) schedule 40 pipe cutting it (2 inches) long lining up a (¼ inch) nut on one end and tack weld it. Now on opposite end take (⅜ inch) flat washer lay hole over hole tack weld now take (⅝ inch)

Flat washer lay over and line with (⅜ inch) washer tack weld on drawing page 3 (FIG. 5c 5d 5e 5f 5g 5h 5i show how they line up. The big washer acts as a dial to tighten or losen nut page 4 of drawing show a (1 and ¼ inch) EMT condiut pipe hanger replacing pipe with flash light handlesthats outside diameters range from (⅛ inch to ¼ inch) larger than outside diameter of pipe, changing hanger to a tite fitting clamp iam replacing (¼ by 1 inch) carriage bolt that tightens clamp to (¼ by 2 inch) so you now can losen clamp tightener so flash light handle can be incerted into clamp without taking clamp tightener off

I found the converted (1 and ¼ inch) EMT number (2 and ½) worked with the flash light I had chosen the converted (1 and ¼ inch) EMT pipe hanger will be serverly tested it will bolt to support pipe using (¼ by 2 inch) hex bolt 4 washers one washer with bolt will go through inside bottom of clamp two more washers will go over bolt for bottom of clamp these two are protecting bottom of clamp from beging bent now but bolt in second hole from top of support pipe but last washer on and tighten with nut. FIG. 5b on drawing page 5 show bolt tightening clamp next step will be incerting oak handle into pipe support first take out bolt that holds clamp second step from top on one side of support pipe make a (4 inch) cut stright down as shown (FIG. 4a) drawing page 5 now take bottom of oak handle knock down in place (4 inches) making a good tight fit know re drill first and second holes from top

Now reinstall clamp and install (¼ by 1 and ¾ inch) hex bolt into first hole at top (1 inch) down use one washer for bottom and tighten (FIG. 5a) drawing page 5 shows bolt. The (4 inch) cut opens abount (3/16inch) now open clamp lay flash light in clamp tighten now go to nearest hole in front of flash light put your stop which is a eye bolt with eye hole facing square with front of the bottom of flash light tighten stop with wing nut now losen clamp adjust flash light until it hits tight againtent stop now retighten clamp stop is on drawing page 4 (FIG. 4c) and page 5

Next file down any sharp edges check for excess bolt threads the clamp tightener covers up the (2 inch) carriage bolt completely the eye bolt from top of eye is (2 and ½ inch) its showing 2 threads the handle bolts are showing (2 and ½) threads drawing pages 6 and 7 show total length of snake blade with light which is (5 feet 11 inches) the oak is (4 feet 8 inch) remember (4 inches) go into support pipe making.

The oak handle that shows (4 feet 4 inches) from the bottom of blade to top of support is (19 inch) its the same as a standard shovel is from bottom of blade to top of steel support. The total weight of snake blade with light is (3 pounds 15 ounces) with out flash light.

Next testing the snake blade with clamp on no flash light in clamp slaming blade into ground cutting roots cutting hose pipe cutting hose pipe on concrete time and time again no problem I did Have to re sharpen blade when hitting concrete. The ash oak handle steel blade steel pipe support will last for years next testing flash light in the clamp after trying several different flash light on dirt and concrete most do good in the dirt but posion snakes can lay on walks made of concrete and drive ways after much testing I found the industrial rayovac held up good on concrete

First going in a more detailed decription of how clamp works the (1 and ¼ inch) EMT pipe hanger that I am using for clamp shown on drawing page 4 was designed to firmly hold (1 and ¼ inch) EMT condiut pipe I tested it when tightened on the (1 and ¼ inch) EMT pipe with pressure applied it will slide on pipe, now replacing pipe with handle of flash light thats handle is round and out side diameter is (1 and ½ inch) the (¼ inch) differents is what makes it clamp down hard on handle of flash light making a tight uniform fit I weigh 190 pounds I could not move flash light in clamp. But I will still use eye bolt stop because with flash light cut on tightened in clamp using a industrial rayovac flash light standard d cell only can be purchased at home depot or lowes for 7 to 8 dollars now iwill strike concrete 50 differentt times with light on more than hard enough to cut snake into after doing several times clamp and light worked good I will make this this my demostration 50 strikes on concrete with light on for any one you do have to resharp blade snakeblade with light was not designed to kill harmless snakes

The snake blade with light was designed to kill poision snakes in your yard where your children play and where you walk some times at night if you are the kind of person that would use a hoe or shovel to kill a poision snake in your yard the snake blade with light was made for you making it much safer it can easily be balances and carried in one hand giving you one hand free to take trash out at night. Light shines down center of blade you do need both hands when cutting the flash light is a accessory to the snake blade and can be taken off if desired.

All bolts washers nuts are carbon steel except (FIG. 5j drawing page 4 (¼ by 2 inch) carriage bolt its stainless reason thraads are stronger and (FIG. 4c) page 4 wing nut only not eye bolt reason wings are stronger

Drawing page 8 shows out side diameter of bottom of oak handle which is (1 and 3/16 inch) also shows side view of clamp flash light and clamp tightener and stop also inside diameter of support pipe which is (1 and ⅛ inch)

1. What I claim as my invention is snake blade with light I claim that the design of blade, support pipe, handle, clamp eye bolt, weld, makes it safer to kill a posion snake with day or night than any garden tool the average person has.
what I claim as my invention is snake blade with light I claim that eye bolt stop, clamptightener, and clamp working together are designed to aim light down center of blade allowing you to see what your cutting at night.
what I claim as my invention is snake blade with light I claim that when not in use of cutting the snake blade and light was designed to easily be balanced and carried in one hand while shinning light in the direction your walking giving you one hand free to take out trash check mail box are other jobs at night.
